(19) United States
(12) Patent Application Publication
(10) Pub. No.: US 2004/0001091 A1
(43) Pub. Date: Jan. 1, 2004

(54) Method and apparatus for video conferencing system with 360 degree view

(75) Inventor: Mark Scott Kressin, Lakeway, TX (US)

Correspondence Address: KUDIRKA & JOBSE, LLP, ONE STATE STREET, SUITE 800, BOSTON, MA, 02109, US

(73) Assignee: International Business Machines Corporation, Armonk, NY

(21) Appl. No.: 10/154,043

(22) Filed: May 23, 2002

(51) Int. Cl. G06F 15/16; G09G 5/00

(52) U.S. Cl. 345/753; 709/205

(57) ABSTRACT

A video conference application supports the use of both conventional and 360 degree cameras in virtual video conferences so that a complete 360 degree image may be transmitted to some or all of the conference participants, with the ability to view all or a part of the 360 degree image and to scroll through the image, as desired. At the recipient system, the video conference application senses whether an image is from a conventional or a 360 degree camera and adjusts the size of the viewing portal on the user interface accordingly. Viewers of 360 degree images are further provided with the option of viewing and scrolling the entire 360 degree image or only a portion thereof.

### RELATED APPLICATIONS

This application is copending and commonly assigned with the following U.S. patent applications all filed Oct. 24, 2000, the subject matters of which are incorporated herein by reference for all purposes, including the following:

U.S. patent application Ser. No. 09/695,193, entitled “Method and Apparatus for Providing Full Duplex and Multipoint IP Audio Streaming”;

U.S. patent application Ser. No. 09/695,553, entitled “Method and Apparatus for Multi-mode IP Audio Streaming”;

U.S. patent application Ser. No. 09/695,203, entitled “Method and Apparatus Two-way Distributed Audio Mixing of Multiway Calls”.

### FIELD OF THE INVENTION

This invention relates, generally, to video conference systems and, more specifically, to a technique for using a 360 degree cameras in video conferencing applications so that the remote video conference attendee can selectively see all or part of a conference room, board room or class room.

### BACKGROUND OF THE INVENTION

Recently, systems for enabling audio and/or video conferencing of multiple parties over packet-switched networks, such as the Internet, have become commercially available. Such systems typically allow participants to simultaneously receive and transmit audio and/or video data streams depending on the sophistication of the system. Conferencing systems used over packet-switched networks have the advantage of not generating long-distance telephone fees and enable varying levels of audio, video, and data integration into the conference forum. In a typical system, a conference server receives audio and/or video streams from the participating client processes to the conference, mixes the streams and retransmits the mixed stream to the participating client processes. Except for cameras, displays and video capture cards most video conferencing systems are implemented in software.

Existing video conferencing applications use standard video cameras that give a very narrow field of view to the remote people that are viewing the video conference. Typically, video conferencing vendors simply leave it up to the user to place the camera so that the remote video conference attendees can see as much of the action. This solution works fine for video conferences that are between individuals. If the video conferencing system is moved to a conference room, board room or class room, it becomes a problem to find a location in the room to place a standard video camera with only a single field of view so that the remote viewers can see anywhere in the room. A prior solution to this problem is to place the camera at one end of the room or in the corner of the room. With such approach, however, it is likely that images of the back of someone's head will be transmitted. Further, action at the end of the room opposite the camera is typically too small for remote viewers to discern.

Attempts have been made to provide a broader range of camera angles to a video teleconference. For example, U.S. Pat. No. 5,686,957, assigned to International Business Machines Corporation, discloses an automatic, voice-directional video camera image steering system that selects segmented images from a selected panoramic video scene, typically around a conference table, so that the participant in the conference currently speaking will be the selected segmented image in the proper viewing aspect ratio, eliminating the need for manual camera movement or automated mechanical camera movement. The system includes an audio detection circuit from an array of microphones that can instantaneously determine the direction of a particular speaker and provide directional signals to a video camera and lens system that electronically selects portions of that image. However, in normal conversational style the image is likely to change at a rate which the viewer may find annoying. In addition, the disclosed system forces the viewer to always see the current speaker, without the ability to selectively view the rest of the conference environment.

In addition, with the advent of the Internet, and widespread use of protocols for real-time transmission of packetized video data, “virtual” video conferences are possible in which the participants exist at disparate locations during the conference.

Accordingly, a need exists for a video conferencing system that allows a viewer to see the video conferencing environment with enough detail.

A further need exists for video conferencing system that enables remote viewers to see all of the participants to a video conference and all the action in a video conferencing environment.

A further need exists for video conferencing system that enables a remote viewer to select a portion of the video conferencing environment as desired.

### SUMMARY OF THE INVENTION

A video conference application supports the use of both conventional and 360 degree cameras in virtual video conferences so that a complete 360 degree image may be transmitted to some or all of the conference participants, with the ability to view all or a part of the 360 degree image and to scroll through the image, as desired. At the recipient system, the video conference application senses whether an image is from a conventional or a 360 degree camera and adjusts the size of the viewing portal on the user interface accordingly. Viewers of 360 degree images are further provided with the option of viewing and scrolling the entire 360 degree image or only a portion thereof.

This invention enables merging of a video conferencing application with camera technology that is capable of capturing a 360 degree view around the camera, allowing a single camera to be placed in the middle of the room. Because the camera captures a full 360 degree field of view around the camera, everything in the room is visible to the remote video conference attendees. The video conferencing application of the present invention offers a remote video conference attendee various viewing techniques to see the room including a full room view displayed in a single window, thus allowing the user to see anything in the room at one time, and a smaller more traditional video window which appears to offer a standard camera narrow field of view but which is actually a view portal into the larger full room image. With such option, the viewer can scroll the view portal over the full room image simulating moving the camera around the room to view any desired location in the room. In addition, when the source of the image changes, i.e., the speaker changes for a 360 degree image to a conventional image, the user interface automatically adjusts the window size accordingly.

According to a first aspect of the invention, in a computer system capable of executing a video conferencing application having a user interface, a method comprises: (A) receiving a sequence of video data packets representing a 360 degree image; (B) assembling the video data packets in memory to recreate the 360 degree image; (C) receiving selection indicia through the user interface indicating a portion of the 360 degree image to be viewed; and (D) displaying the selected portion of the 360 degree image through the user interface. In one embodiment, the step of displaying further comprises displaying either a selected portion of the 360 degree image of the entire 360 degree image through a viewing portal of predetermined size on the user interface. In another embodiment, the method further comprises the steps of (C1) receiving directional indicia through the user interface indicating a different portion of the 360 degree image to be viewed; and (D1) displaying substantially continuous portions of the 360 degree image through a viewing portal of predetermined size in a scrolling manner.

According to a second aspect of the invention, a computer program product for use with a computer system capable of executing a video conferencing application with a user interface, the computer program product comprising a computer useable medium having embodied therein program code comprising: A) program code for receiving a sequence of video data packets representing a 360 degree image; B) program code for assembling the video data packets in memory to recreate the 360 degree image; C) program code for receiving selection indicia through the user interface indicating a portion of the 360 degree image to be viewed; and D) program code for displaying the selected portion of the 360 degree image through the user interface.

According to a third aspect of the invention, in a computer system capable of executing a video conferencing application with a user interface, a method comprises: (A) receiving a sequence of video data packets representing a 360 degree image; (B) assembling the video data packets in a video buffer to recreate the 360 degree image; (C) receiving selection indicia through the user interface indicating one of all or a portion of the 360 degree image to be displayed; and (D) displaying one of all or a portion of he 360 degree image through the user interface in accordance with the selection indicia.

According to a fourth aspect of the invention, in a computer system capable of executing a video conferencing application with a user interface, a method comprises: (A) receiving a video data packet sequence representing a corresponding video image from one of a plurality of sources, selected of the a plurality of sources generating video images of different sizes; (B) determining from the received video data packet sequence the size of the corresponding video image from the source; (C) presenting the video image through a window on the user interface, the size of the window corresponding with the size of the video image from the source.

According to a fifth aspect of the invention, a computer program product for use with a computer system capable of executing a video conferencing application with a user interface, the computer program product comprising a computer useable medium having embodied therein program code comprising: A) program code for receiving a video data packet sequence representing a corresponding video image from one of a plurality of sources, selected of the a plurality of sources generating video images of different sizes; B) program code for determining from the received video data packet sequence the size of the corresponding video image from the source; and C) program code for presenting the video image through a window on the user interface, the size of the window corresponding with the size of the video image from the source.

According to a sixth aspect of the invention, an apparatus for use with a computer system capable of executing a video conferencing application with a user interface, the apparatus for controlling processor utilization during video conferencing comprising: (A) program logic for receiving a video data packet sequence representing a corresponding video image from one of a plurality of sources, selected of the a plurality of sources generating video images of different sizes; (B) program logic for determining from the received video data packet sequence the size of the corresponding video image from the source; and (C) program logic for presenting the video image through a window on the user interface, the size of the window corresponding with the size of the video image from the source.

According to a seventh aspect of the invention, a system for displaying 360 degree images in a video conference comprises: (A) a source process executing on a computer system for generating sequence of video data packets representing a 360 degree image; (B) a server process executing on a computer system for receiving the sequence of video data packets from the source process and for transmitting the sequence of video data packets to a plurality of receiving processes; and (C) a plurality of receiving processes, each receiving process executing on a computer system, selected of the receiving processes capable of displaying one of all or a portion of the 360 degree image through a user interface.

### BRIEF DESCRIPTION OF THE DRAWINGS

The above and further advantages of the invention may be better understood by referring to the following description in conjunction with the accompanying drawings in which:

FIG. 1 is a block diagram of a computer systems suitable for use with the present invention;

FIG. 2 is a illustrates conceptually the relationship between the components of the system in which the present invention may be utilized;

FIG. 3 is a block diagram conceptually illustrating the functional components of the multimedia conference server in accordance with the present invention;

FIG. 4 is a illustrates conceptually a system for capturing and receiving video data;

FIG. 5 is an illustration of a prior art RTP packet header;

FIGS. 6A-B form a flow chart illustrating the process steps performed during the present invention;

FIG. 7 is screen capture of a user interface in which a complete 360 degree image is viewable in accordance with the present invention; and

FIG. 8 is screen capture of a user interface in which a portion of a 360 degree image is viewable in accordance with the present invention.

### DETAILED DESCRIPTION

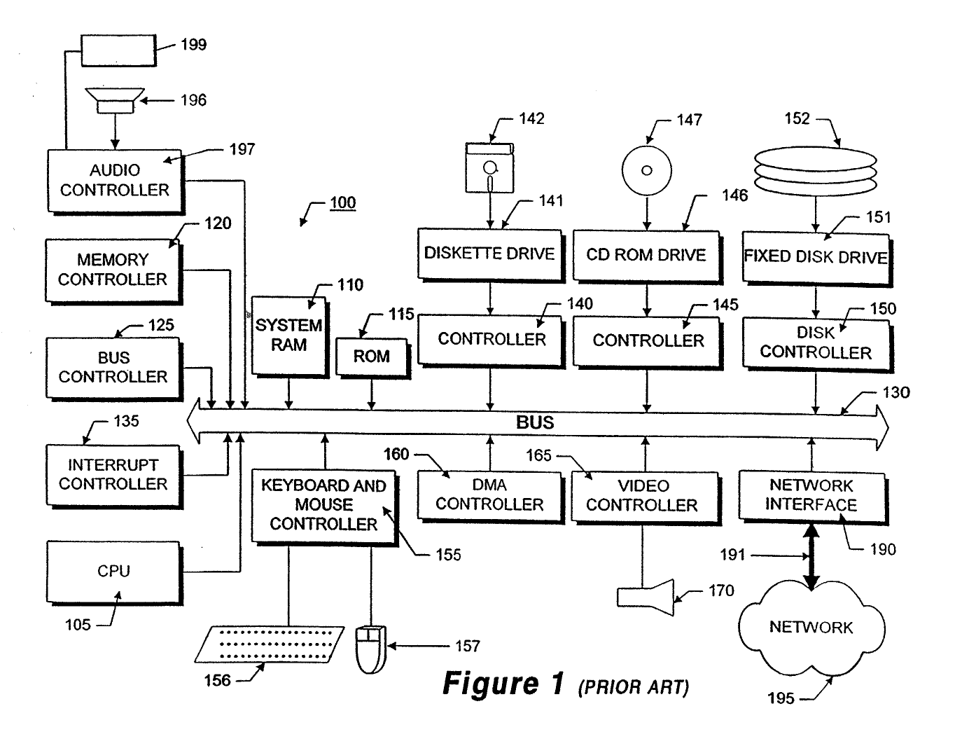

FIG. 1 illustrates the system architecture for a computer system 100, such as a Dell Dimension 8200, commercially available from Dell Computer, Dallas Tex., on which the invention can be implemented. The exemplary computer system of FIG. 1 is for descriptive purposes only. Although the description below may refer to terms commonly used in describing particular computer systems, the description and concepts equally apply to other systems, including systems having architectures dissimilar to FIG. 1.

The computer system 100 includes a central processing unit (CPU) 105, which may include a conventional microprocessor, a random access memory (RAM) 110 for temporary storage of information, and a read only memory (ROM) 115 for permanent storage of information. A memory controller 120 is provided for controlling system RAM 110. A bus controller 125 is provided for controlling bus 130, and an interrupt controller 135 is used for receiving and processing various interrupt signals from the other system components. Mass storage may be provided by diskette 142, CD ROM 147 or hard drive 152. Data and software may be exchanged with computer system 100 via removable media such as diskette 142 and CD ROM 147. Diskette 142 is insertable into diskette drive 141 which is, in turn, connected to bus 130 by a controller 140. Similarly, CD ROM 147 is insertable into CD ROM drive 146 which is connected to bus 130 by controller 145. Hard disk 152 is part of a fixed disk drive 151 which is connected to bus 130 by controller 150.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio/video controller 197, as illustrated. A camera or other video capture device 199 is connected to bus 130 by audio/video controller 197, as illustrated. In the illustrative embodiment, video capture device 199 may be any conventional video camera or a 360 degree camera capable of capturing an entire 360 degree field of view. It will be obvious to those reasonably skilled in the art that other input devices such as a pen and/or tablet and a microphone for voice input may be connected to computer system 100 through bus 130 and an appropriate controller/software. DMA controller 160 is provided for performing direct memory access to system RAM 110. A visual display is generated by video controller 165 which controls video display 170. In the illustrative embodiment, the user interface of a computer system may comprise a video display and any accompanying graphic use interface presented thereon by an application or the operating system, in addition to or in combination with any keyboard, pointing device, joystick, voice recognition system, speakers, microphone or any other mechanism through which the user may interact with the computer system. Computer system 100 also includes a communications adapter 190 which allows the system to be interconnected to a local area network (LAN) or a wide area network (WAN), schematically illustrated by bus 191 and network 195.

Computer system 100 is generally controlled and coordinated by operating system software, such as the WINDOWS NT, WINDOWS XP or WINDOWS 2000 operating system, available from Microsoft Corporation, Redmond Wash. The operating system controls allocation of system resources and performs tasks such as process scheduling, memory management, and networking and I/O services, among other things. In particular, an operating system resident in system memory and running on CPU 105 coordinates the operation of the other elements of computer system 100. The present invention may be implemented with any number of commercially available operating systems including OS/2, AIX, UNIX and LINUX, DOS, etc. One or more applications 220 such as Lotus Notes or Lotus Sametime, both commercially available from Lotus Development Corp., Cambridge, Mass. may execute under control of the operating system. If operating system 210 is a true multitasking operating system, multiple applications may execute simultaneously.

In the illustrative embodiment, the present invention may be implemented using object-oriented technology and an operating system which supports execution of object-oriented programs. For example, the inventive control program module may be implemented using the C++ language or as well as other object-oriented standards, including the COM specification and OLE 2.0 specification for MicroSoft Corporation, Redmond, Wash., or, the Java programming environment from Sun Microsystems, Redwood, Calif.

In the illustrative embodiment, the elements of the system are implemented in the C++ programming language using object-oriented programming techniques. C++ is a compiled language, that is, programs are written in a human-readable script and this script is then provided to another program called a compiler which generates a machine-readable numeric code that can be loaded into, and directly executed by, a computer. As described below, the C++ language has certain characteristics which allow a software developer to easily use programs written by others while still providing a great deal of control over the reuse of programs to prevent their destruction or improper use. The C++ language is well-known and many articles and texts are available which describe the language in detail. In addition, C++ compilers are commercially available from several vendors including Borland International, Inc. and Microsoft Corporation. Accordingly, for reasons of clarity, the details of the C++ language and the operation of the C++ compiler will not be discussed further in detail herein.

Video Compression Standards

When sound and video images are captured by computer peripherals and are encoded and transferred into computer memory, the size (in number of bytes) for one seconds worth of audio or a single video image can be quite large. Considering that a conference is much longer than 1 second and that video is really made up of multiple images per second, the amount of multimedia data that needs to be transmitted between conference participants is quite staggering. To reduce the amount of data that that needs to flow between participants over existing non-dedicated network connections, the multimedia data can be compressed before it is transmitted and then decompressed by the receiver before it is rendered for the user. To promote interoperability, several standards have been developed for encoding and compressing multimedia data.

H.263 is a video compression standard which is optimized for low bitrates (<64 k bits per second) and relatively low motion (someone talking). Although the H.263 standard supports several sizes of video images, the illustrative embodiment uses the size known as QCIF. This size is defined as 176 by 144 pixels per image. A QCIF—sized video image before it is processed by the H.263 compression standard is 38016 bytes in size. One seconds worth of full motion video, at thirty images per second, is 1,140,480 bytes of data. In order to compress this huge amount of data into a size of about 64 k bits, the compression algorithm utilizes the steps of: i) Differential Imaging; ii) Motion estimation/compensation; iii) Discrete Cosine Transform (DCT) Encoding; iv) Quantization and v) Entropy encoding.

The first step in reducing the amount of data that is needed to represent a video image is Differential Imaging, that is, to subtract the previously transmitted image from the current image so that only the difference between the images is encoded. This means that areas of the image that do not change, for example the background, are not encoded. This type of image is referred to as a “D” frame. Because each “D” frame depends on the previous frame, it is common practice to periodically encode complete images so that the decoder can recover from “D” frames that may have been lost in transmission or to provide a complete starting point when video is first transmitted. These much larger complete images are called “I” frames. Typically, human beings perceive 30 frames per second as real motion video, however, this can drop as low as 10-15 per second to still be perceptible as video images. The H.263 codec is a bitrate managed codec, meaning the number of bits that are utilized to compress a video frame into an I-frame is different than the number of bits that are used to compress each D-frame. Compressing only the visual changes between the delta frame and the previously compressed frame makes a delta frame. As the encoder compresses frames into either the I-frame or D-frame, the encoder may skip video frames as needed to maintain the video bitrate below the set bitrate target.

The next step in reducing the amount of data that is needed to represent a video image is Motion estimation/compensation. The amount of data that is needed to represent a video image is further reduced by attempting to locate where areas of the previous image have moved to in the current image. This process is called motion estimation/compensation and reduces the amount of data that is encoded for the current image by moving blocks (16×16 pixels) from the previously encoded image into the correct position in the current image.

The next step in reducing the amount of data that is needed to represent a video image is Discrete Cosine Transform (DCT) Encoding. Each block of the image that must be encoded because it was not eliminated by either the differential images or the motions estimation/compensation steps is encoded using Discrete Cosine Transforms (DCT). These DCT are very good at compressing the data in the block into a small number of coefficients. This means that only a few DCT coefficients are required to recreate a recognizable copy of the block.

The next step in reducing the amount of data that is needed to represent a video image is Quantization. For a typical block of pixels, most of the coefficients produced by DCT encoding are close to zero. The quantizer step reduces the precision of each coefficient so that the coefficients near zero are set to zero leaving only a few significant non-zero coefficients.

The next step in reducing the amount of data that is needed to represent a video image is Entropy encoding. The last step is to use an entropy encoder (such as a Huffman encoder) to replace frequently occurring values with short binary codes and replaces infrequently occurring values with longer binary codes. This entropy encoding scheme is used to compress the remaining DCT coefficients into the actual data that that represents the current image. Further details regarding the H.263 compression standard can be obtained from the ITU-T H.263 available from the International Telecommunications Union, Geneva, Switzerland.

The H.263 compression standard is typically used for video data images of standard size. The ITU-T H.263+ video compression standard is utilized to encode and decode nonstandard video image sizes such as those generated by 360 degree cameras.

Sametime Environment

The illustrative embodiment of the present invention is described in the context of the Sametime family of real-time collaboration software products, commercially available from Lotus Development Corporation, Cambridge, Mass. The Sametime family of products provide awareness, conversation, and data sharing capabilities, the three foundations of real-time collaboration. Awareness is the ability of a client process, e.g. a member of a team, to know when other client processes, e.g. other team members, are online. Conversations are networked between client processes and may occur using multiple formats including instant text messaging, audio and video involving multiple client processes. Data sharing is the ability of client processes to share documents or applications, typically in the form of objects. The Sametime environment is an architecture that consists of Java based clients that interact with a Sametime server. The Sametime clients are built to interface with the Sametime Client Application Programming Interface, published by International Business machines corporation, Lotus Division, which provides the services necessary to support these clients and any user developed clients with the ability to setup conferences, capture, transmit and render audio and video in addition to interfacing with the other technologies of Sametime.

The present invention may be implemented as an all software module in the Multimedia Service extensions to the existing family of Sametime 1.0 or 1.5 products and thereafter. Such Multimedia Service extensions are included in the Sametime Server 300, the Sametime Connect client 310 and Sametime Meeting Room Client (MRC) 312.

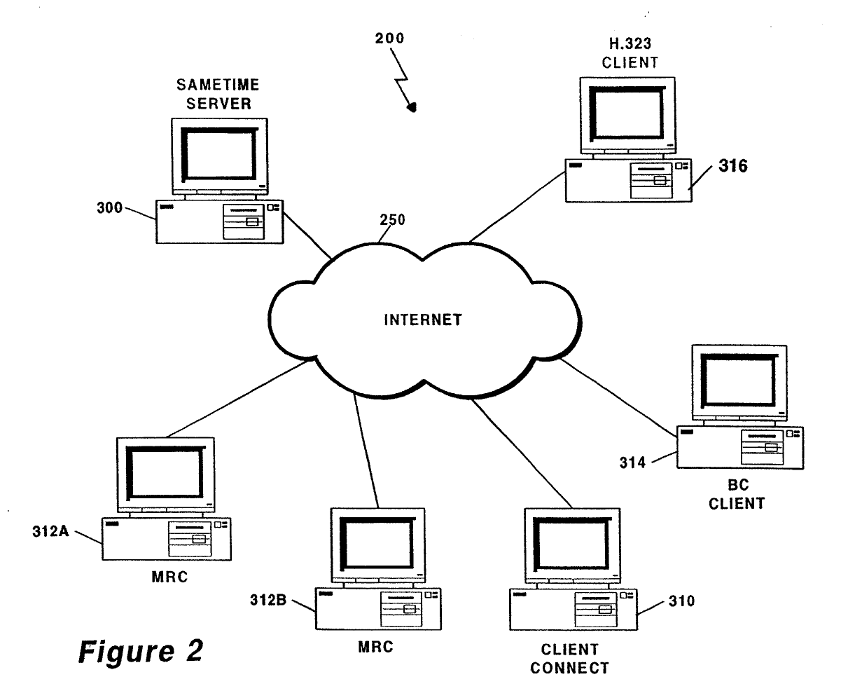

FIG. 2 illustrates a network environment in which the invention may be practiced, such environment being for exemplary purposes only and not to be considered limiting. Specifically, a packet-switched data network 200 comprises a Sametime server 300, a plurality of Meeting Program Client (MRC) client processes 312A-B, a Broadcast Client (BC) client 314, an H.323 client process 316, a Sametime Connect client 310 and an Internet network topology 250, illustrated conceptually as a cloud. One or more of the elements coupled to network topology 250 may be connected directly or through Internet service providers, such as America On Line, Microsoft Network, Compuserve, etc.

The Sametime MRC 312, may be implemented as a thin mostly Java client that provides users with the ability to source/render real-time audio/video, share applications/whiteboards and send/receive instant messages in person to person conferences or multi-person conferences. The Sametime BC 314 is used as a “receive only” client for receiving audio/video and shared application/whiteboard data that is sourced from the MRC client 312. Unlike the MRC client, the BC client does not source audio/video or share applications. Both the MRC and BC clients run under a web browser and are downloaded and cached as need when the user enters a scheduled Sametime audio/video enabled meeting, as explained hereinafter in greater detail.

The client processes 310, 312, 314, and 316 may likewise be implemented as part of an all software application that run on a computer system similar to that described with reference to FIG. 1, or other architecture whether implemented as a personal computer or other data processing system. In the computer system on which a Sametime client process is executing, a sound/video card, such as card 197 accompanying the computer system 100 of FIG. 1, may be an MCI compliant sound card while a communication controller, such as controller 190 of FIG. 1, may be implemented through either an analog digital or cable modem or a LAN-based TCP/IP network connector to enable Internet/Intranet connectivity.

Server 300 may be implemented as part of an all software application which executes on a computer architecture similar to that described with reference to FIG. 1. Server 300 may interface with Internet 250 over a dedicated connection, such as a T1, T2, or T3 connection. The Sametime server is responsible for providing interoperability between the Meeting Room Client and H.323 endpoints. Both Sametime and H.323 endpoints utilize the same media stream protocol and content differing in the way they handle the connection to server 300 and setup of the call. The Sametime Server 300 supports the T.120 conferencing protocol standard, published by the ITU, and is also compatible with third-party client H.323 compliant applications like Microsoft's NetMeeting and Intel's ProShare. The Sametime Server 300 and Sametime Clients work seamlessly with commercially available browsers, such as NetScape Navigator version 4.5 and above, commercially available from America On-line, Reston, Va.; Microsoft Internet Explorer version 4.01 service pack 2 and above, commercially available from Microsoft Corporation, Redmond, Wash. or with Lotus Notes, commercially available from Lotus Development Corporation, Cambridge, Mass.

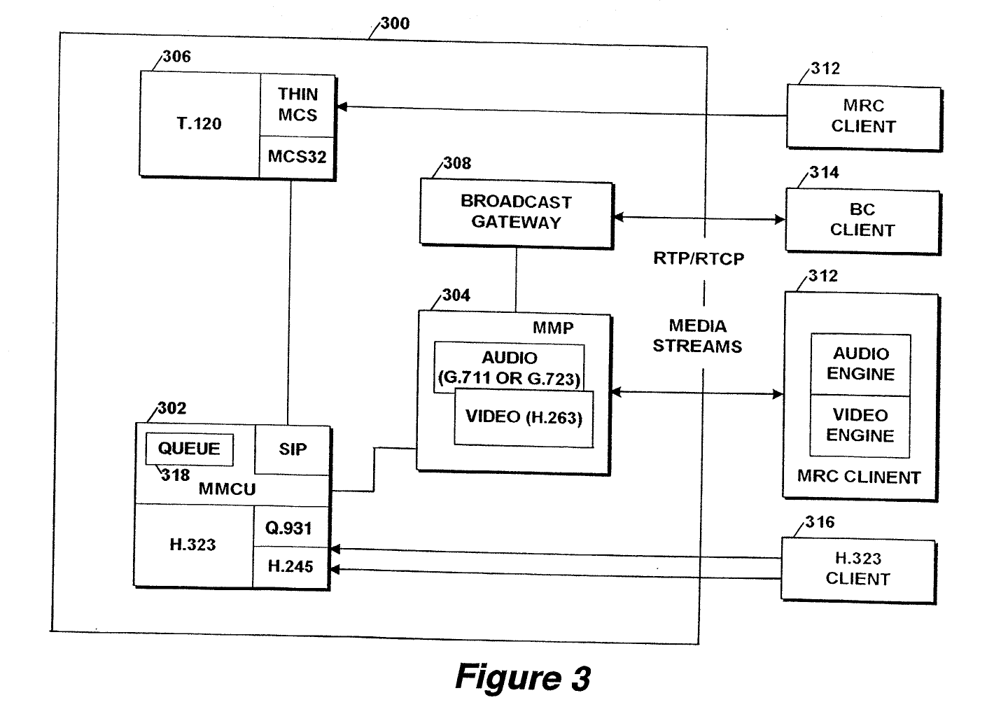

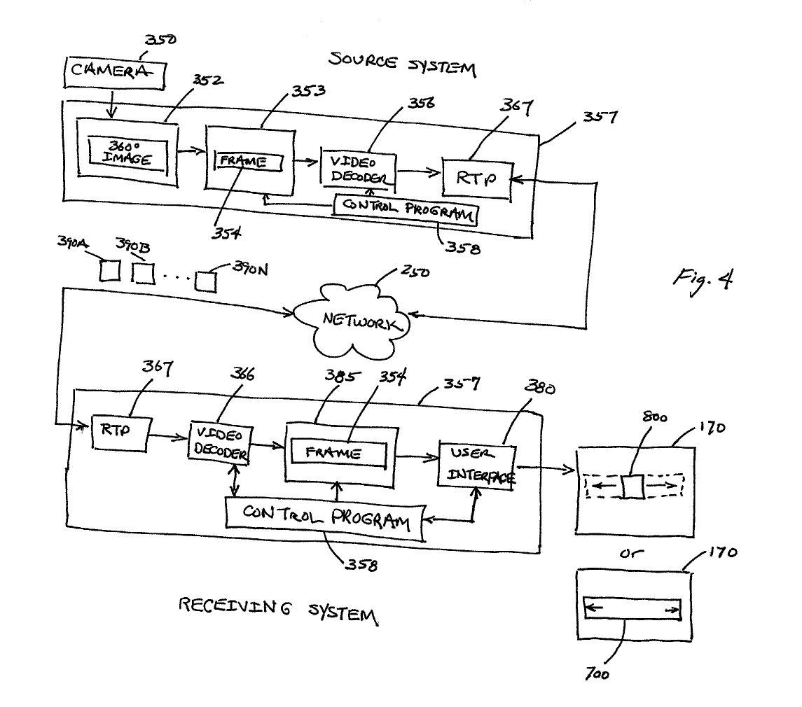

FIG. 3 illustrates conceptually a block diagram of a Sametime server 300 and MRC Client 312, BC Client 314 and an H.323 client 316. As illustrated, both MRC Client 312 and MMP 304 include audio and video engines, including the respective audio and video codecs. The present invention effects the video stream forwarded from a client to MMP 304 of server 300.

In the illustrative embodiment, the MRC and BC component of Sametime environment may be implemented using object-oriented technology. Specifically, the MRC and BC may be written to contain program code which creates the objects, including appropriate attributes and methods, which are necessary to perform the processes described herein and interact with the Sametime server 300 in the manner described herein. Specifically, the Sametime clients includes a video engine which is capable of capturing video data, compressing the video data, transmitting the packetized audio data to the server 300, receiving packetized video data, decompressing the video data, and playback of the video data. Further, the Sametime MRC client includes an audio engine which is capable of detecting silence, capturing audio data, compressing the audio data, transmitting the packetized audio data to the server 300, receiving and decompressing one or more streams of packetized audio data, mixing multiple streams of audio data, and playback of the audio data. Sametime clients which are capable of receiving multiple audio streams also perform mixing of the data payload locally within the client audio engine using any number of known algorithms for mixing of multiple audio streams prior to playback thereof. The codecs used within the Sametime clients for audio and video may be any of those described herein or other available codecs.

The Sametime MRC communicates with the MMCU 302 for data, audio control, and video control, the client has a single connection to the Sametime Server 300. During the initial connection, the MMCU 302 informs the Sametime MRC client of the various attributes associated with a meeting. The MMCU 302 informs the client process which codecs to use for a meeting as well as any parameters necessary to control the codecs, for example the associated frame and bit rate for video and the threshold for processor usage, as explained in detail hereinafter. Additional information regarding the construction and functionality of server 300 and the Sametime clients 312 and 314 can be found in the previously-referenced co-pending applications.

It is within this framework that an illustrative embodiment of the present invention is being described, it being understood, however, that such environment is not meant to limit the scope of the invention or its applicability to other environments. Any system in which video data is captured and presented by a video encoder can utilize the inventive concepts described herein.

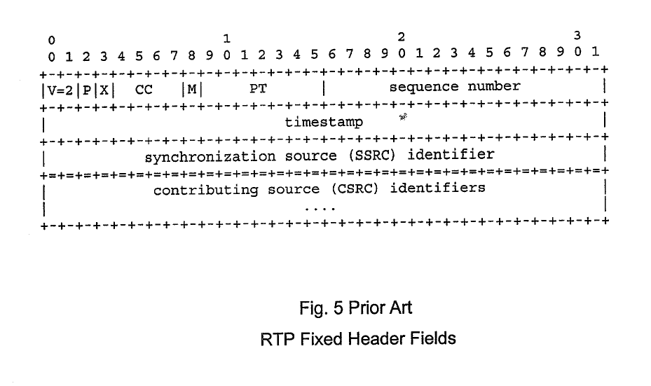

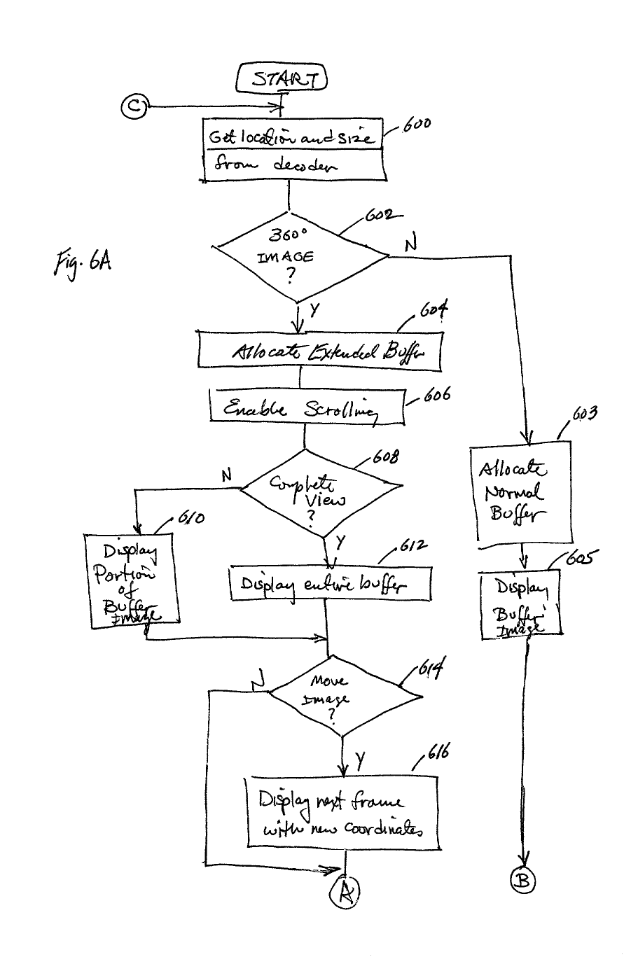

Referring to FIG. 4, video images are captured with camera 350, which in the illustrative embodiment may include either a traditional video camera or a 360 degree camera at the video conference participant's location. A 360 degree camera suitable for use with the present invention may be the TotalView High Res package, commercially available from BeHere Corporation, Cupertino, Calif., 95014, which includes a DVC MegaPixel Video Camera, and a PCI Video Capture Board. The DVC MegaPixel Video Camera includes a conical lense which generates a spherical image. The spherical image is processed with the PCI Video Capture Board to dewarp the video data, allowing the three-dimensional image to be converted to a two-dimensional image and stored in a video buffer therein. The two-dimensional image supplied by the PCI Video Capture Board is approximately 768×192 pixels, e.g., a long, thin two-dimensional image.

FIGS. 4-5 illustrate conceptually the components of the inventive system utilized to generate and process a video data stream in accordance with the present invention. As described previously, the video conferencing application 357 may be implemented with the Sametime 2.0. The operating system 362 may be implemented with any of the Windows operating system products including WINDOWS 95, WINDOW 98, WINDOWS 2000, WINDOWS XP, etc. As such either a conventional camera or the 360 degree camera described above will be considered by the operating system as a Video for Windows device. Upon initial configuration of the video conferencing application 357 the user specifies whether the video capture device is a conventional camera of a 360 degree camera.

Camera 350 captures a continual stream of video data and stores the data in a video buffer in the accompanying video processing card where the three-dimensional image is processed to dewarp the image and convert the processed three-dimensional image into a two-dimensional image. The device driver 360 for camera 350 periodically transfers the image data from the camera/card to the frame buffer 352 associated with the device driver 360. An interrupt generated by the video conferencing application 357 requests a frame from the frame buffer 352. Prior to the providing the frame of captured video data to video encoder 356, control program 358 may optionally modify the size of the image prior to transmission of the frame 354 to video encoder 356. For example, in the illustrative embodiment, the viewing window or portal presented by the user interface 365 of video conferencing application 357 is capable of displaying an image that is approximately 144 pixels in height. Accordingly, the image in buffer 352 may be cropped to 768×144 pixels. To crop the buffered image, control program 358 allocates a second video buffer 353, that may be smaller e.g., 768×144, and extracts the image data of interest from buffer 352 and writes the image data into buffer 353. Control program 358 then specifies the size of the image to be compressed in pixels to video encoder 356 prior to compression thereof. Accordingly, the video image to be compressed may have some the top most and bottom most pixel lines eliminated.

Thereafter, the video image from buffer 353 is provided to video encoder 356 for compression of the video data in accordance with the published H.263+ specification. Control program 358 indicates to video encoder 356 when the video data supplied to the encoder 356 is of a custom picture format based on the value of the image size supplied to video encoder 356. When a video frame is compressed with video encoder 356 using the H.263+ standard, a header is associated with the compressed data, the header indicating the size of the compressed video image. Specifically, a fixed length code word of 23 bits, referred to as the Custom Picture Format (CPFMT) field, is present only in the header if the use of a custom picture format is signaled in the PLUSPTYPE field of the H.263 header and the UFEP field of the H.263 header has a value of ‘001’. When present, the CPFMT field has the following format:

| | |
|---|---|
| Bits 1-4 | Pixel Aspect Ratio Code: A 4-bit index to the PAR value in |
| | Table 5 of the H.263+ Specification. For extended PAR, |
| | the exact pixel aspect ratio shall be specified in EPAR value |
| | in Table 5.16 of the H.263+ Specification; |
| Bits 5-13 | Picture Width Indication (PWI): Range [0, . . . , 511]; |
| | Number of pixels per line = (PWI + 1) * 4; |
| Bit 14 | Equal to “1” to prevent start code emulation; |
| Bits 15-23 | Picture Height Indication (PHI) : Range [1, . . . , 288]; |
| | Number of lines = PHI * 4. |

The compressed output from video encoder 356, including the video data and the header, are provided to RTP protocol module 367 which places a wrapper around the compressed video data in accordance with the Real Time Transport (RTP) protocol. Code within RTP protocol module 367 sets two fields in the RTP header when a single video image is broken up into multiple packets for transport over a network. Within the RTP header, as illustrated in prior art FIG. 5, the fields of interest are the Marker bit (M) and the Sequence Number. The Marker bit (M) of the RTP fixed header is set to 1 when the current packet carries the end of current frame, otherwise the Marker bit is set to 0. The Marker bit is intended to allow significant events such as frame boundaries to be marked in the packet stream. The value of the Sequence Number field (16 bits) increments by one for each RTP data packet sent, and may be used by the receiving video conferencing process to detect packet loss and to restore packet sequence. The initial value of the sequence number may be random, e.g. unpredictable, to make known-plain text attacks on encryption more difficult. Additional information regarding the RTP and H.263 protocols can be found in the ITU RFC 1889 Realtime Transport Protocol; ITU RFC 2190 RTP Payload Format for H.263 Video Streams; and ITU H.263 Video coding for low bit rate communication, all publicly available from the International Telecommunications Union, Geneva, Switzerland.

Following compression and packetizing of the image, the image is transmitted as a series of packets 390A-N to one or more recipient participants to the video conference. The packets 390A-N are transmitted from the source video conferencing system on which application 357 is executing through the network 250 to one or more receiving systems on which video conferencing application 357 is executing. In the illustrative embodiment, described with reference to the Sametime environment, the packetized data will be sent from the source video conferencing process, to a Sametime server, such as server 300 described previously but not shown in FIG. 4, and subsequently transmitted to the receiving video conferencing processes.

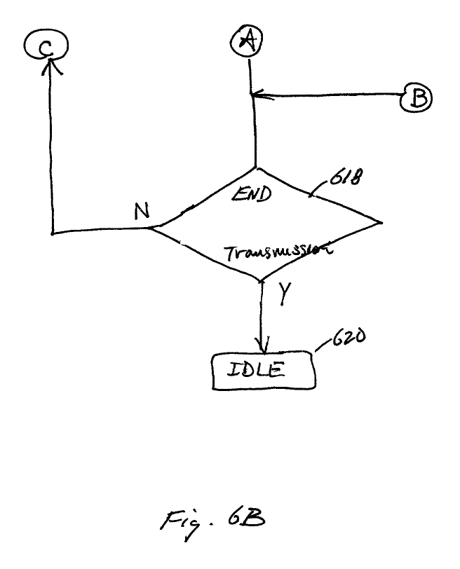

Referring to FIGS. 6A-B, the process performed by control program 358 during the reception decompression and presentation of video data is illustrated. Following receipt of the sequence of packets comprising the image, the previously described process is reversed. Using the Sequence Number field to put the packets back in order and to make a determination as to where a video frame or a single video image starts and ends by examining the marker bit, RTP protocol module 367 arranges the sequence of packets into order and supplies them to video decoder 366. Control program 358 places a procedure call to video decoder 366 which returns a pointer value, indicating the location of the decompressed data, and a size value, indicating the size of the decompresses data, as illustrated by step 600. Based on a size value, a buffer of the appropriate size is allocated by control program 358 and the decompressed video data output from decoder 366 is written into video buffer 375. If the size value supplied by video decoder 366 indicates a 360 degree image, a buffer of appropriate size will be allocated, as illustrated by steps 602 and 604, a scrolling function is enabled within control program 358, as illustrated by 606. If the size value supplied by video decoder 366 indicates a conventional video image, a buffer 385 of appropriate size will be allocated and the image will be provided to the user interface module 380 of application 357 for presentation to the viewer, as illustrated in steps 602, 603 and 605.

Thereafter, if the image is a 360 degree image, control program 358 determines the mode in which the viewer wishes to receive the 360 degree image, as illustrated by decisional step 608. Such determination may be made by default or through receipt of command indicia through user interface 380. The video conferencing application 357 of the present invention provides multiple options for viewing a 360 degree image. Since the extended video image resides in the local video buffer of a viewer participant's system, the user may select, through the user interface, to view the entire image or a portion thereof through a viewing portal. If the user desires to view the entire image, the complete contents of the video buffer will be displayed within the viewing portal on the graphic user interface, as illustrated in step 612. If the viewer indicates that less than all of the entire 360 degree image is to be viewed, an initial portion of the video buffer data, representing, for example, the center portion of the 360 degree image will be presented within a viewing portal, as illustrated in step 610.

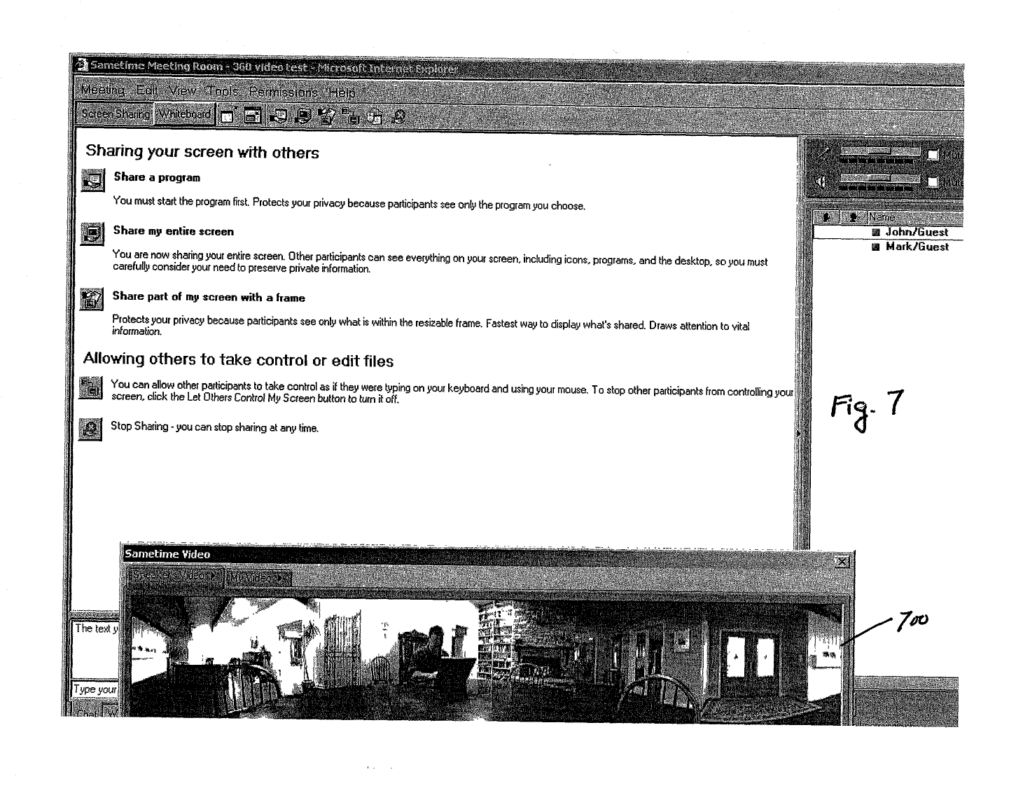

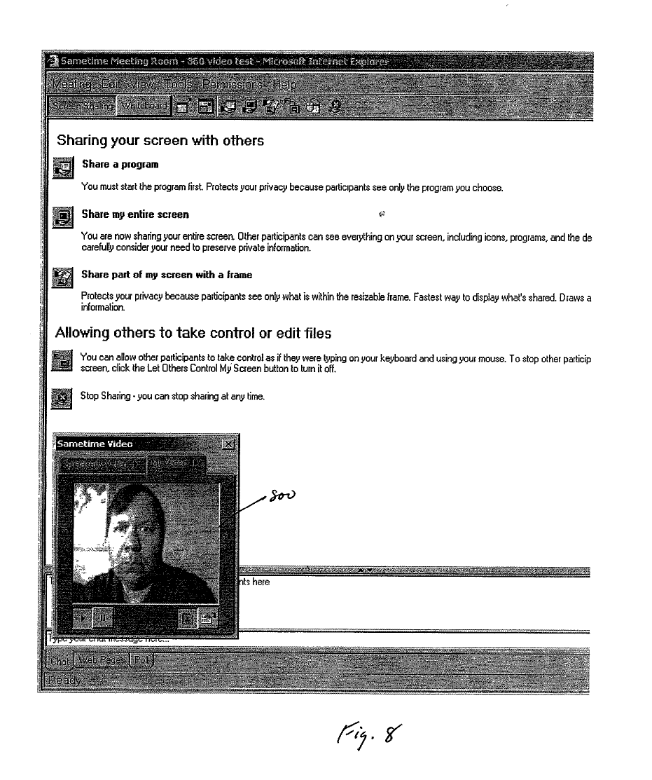

In the illustrative embodiment, the entire 360 degree image, approximately 768×144 pixels, may be presented through the viewing portal 700 which may “float” anywhere on the user interface of the video conferencing application 357, as illustrated in FIG. 7, or alternatively may have a default or “docked” position on the user interface. Alternatively, the user may choose to view less than all of the 360 degree image at a single instance, in which case the user interface will display a conventional or reduced size viewing portal 800, such as approximately 176×144 pixels, as illustrated in FIG. 8. As with viewing portal 700, viewing portal 800 may float or be docked on the user interface.

Thereafter, if the image is a 360 degree image, the user may selectively control the portions of the extended image presented through the user interface. In the illustrative embodiment, movement of a pointing device cursor within the viewing portal 800 or 900, converts the cursor to directional cursor. Thereafter, movement of the cursor in one of the designated directions, e.g., left, right, up, or down, causes the viewing portal, whether 176×144 pixels or 768×144 pixels, will be detected by control program 358 an cause the next frame displayed to scroll in the designated direction to allow for selective viewing of different portions of the 360 degree image, as illustrated by steps 614 and 616. Continuous scrolling of the image may cause the image to “wrap around” to provide a continuously viewable 360 degree image. In this manner, as the viewing portal is moved in the direction of movement of the pointing device cursor, the portion of the 360 degree image is displayed within the viewing portal scrolls continuously. This process continues until the transmission from another source is terminated, as illustrated by steps 618 and 620, or until the next set of received data packets indicates a different source, as illustrated by steps 618 and 600.

In accordance with another aspect of the present invention, the video conferencing application 357 automatically adjusts the dimensions of the viewing portal on the user interface in accordance with the size of the currently received video data. As the source of the video data changes, i.e., the speaker changes to a different location/system, control program 358 detects the size of the video image and automatically adjusts the size of the viewing portal presented by the user interface. If in steps 600 and 602, the size of the image reported by the video decoder indicated that the image is of a conventional size, the dimensions of the viewing portal on the user interface will be resized for a conventional video image and the scrolling function of control program 358 will be disabled, if the image previously displayed was a 360 degree image. In this manner, in a video conference having multiple participants where one participant is utilizing a conventional video camera and another participant is utilizing a 360 degree camera, the video conferencing application 357 will automatically adjust the initial dimensions of the viewing portal on the user interface without further commands from the viewer. The reader will appreciate that the present invention provides a technique in which a complete 360 degree image is transmitted from a source to some or all of the participants to a virtual video conference, with the ability for the recipient participants to view all or a part of the 360 degree image and to scroll through the image, as desired.

Although the invention has been described with reference to the H.263 and H.263+ video codecs, it will be obvious to those skilled in the arts that other video encoding standards, such as H.261 may be equivalently substituted and still benefit from the invention described herein. In addition, the present invention may be used with a general purpose processor, such as a microprocessor based CPU in a personal computer, PDA or other device or with a system having a special purpose video or graphics processor which is dedicated to processing video and/or graphic data.

A software implementation of the above-described embodiments may comprise a series of computer instructions either fixed on a tangible medium, such as a computer readable media, e.g. diskette 142, CD-ROM 147, ROM 115, or fixed disk 152 of FIG. 1A, or transmittable to a computer system, via a modem or other interface device, such as communications adapter 190 connected to the network 195 over a medium 191. Medium 191 can be either a tangible medium, including but not limited to optical or analog communications lines, or may be implemented with wireless techniques, including but not limited to microwave, infrared or other transmission techniques. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, preloaded with a computer system, e.g., on system ROM or fixed disk, or distributed from a server or electronic bulletin board over a network, e.g., the Internet or World Wide Web.

Although various exemplary embodiments of the invention have been disclosed, it will be apparent to those skilled in the art that various changes and modifications can be made which will achieve some of the advantages of the invention without departing from the spirit and scope of the invention. Further, many of the system components described herein have been described using products from International Business Machines Corporation. It will be obvious to those reasonably skilled in the art that other components performing the same functions may be suitably substituted. Further, the methods of the invention may be achieved in either all software implementations, using the appropriate processor instructions, or in hybrid implementations which utilize a combination of hardware logic and software logic to achieve the same results. Although an all software embodiment of the invention was described, it will be obvious to those skilled in the art that the invention may be equally suited for use with video system the use firmware or hardware components to accelerate processing of video signals. Such modifications to the inventive concept are intended to be covered by the appended claims.

What is claimed is:

1. In a computer system capable of executing a video conferencing application having a user interface, a method comprising:
(A) receiving a sequence of video data packets representing a 360 degree image;
(B) assembling the video data packets in memory to recreate the 360 degree image;
(C) receiving selection indicia through the user interface indicating a portion of the 360 degree image to be viewed; and
(D) displaying the selected portion of the 360 degree image through the user interface.

2. The method of claim 1 wherein (D) further comprises:
(D1) displaying the selected portion of the 360 degree image through a viewing portal of predetermined size on the user interface.

3. The method of claim 1 wherein (C) further comprises:
(C1) receiving directional indicia through the user interface indicating a different portion of the 360 degree image to be viewed;
and wherein (D) further comprises:
(D1) displaying substantially continuous portions of the 360 degree image through a viewing portal of predetermined size in a scrolling manner.

4. The method of claim 1 further comprising:
(E) displaying the entire 360 degree image video through the user interface.

5. A computer program product for use with a computer system capable of executing a video conferencing application with a user interface, the computer program product comprising a computer useable medium having embodied therein program code comprising:
A) program code for receiving a sequence of video data packets representing a 360 degree image;
B) program code for assembling the video data packets in memory to recreate the 360 degree image;
C) program code for receiving selection indicia through the user interface indicating a portion of the 360 degree image to be viewed; and
D) program code for displaying the selected portion of the 360 degree image through the user interface.

6. The computer program product of claim 5 wherein (D) further comprises:
(D1) program code for displaying the selected portion of the 360 degree image through a viewing portal of predetermined size on the user interface.

7. The computer program product of claim 5 wherein (C) further comprises:
(C1) program code for receiving directional indicia through the user interface indicating a different portion of the 360 degree image to be viewed;
and wherein (D) further comprises:
(D1) program code for displaying substantially continuous portions of the 360 degree image through a viewing portal of predetermined size in a scrolling manner.

8. The computer program product of claim 5 further comprising:
(E) program code for displaying the entire 360 degree image video through the user interface.

9. In a computer system capable of executing a video conferencing application with a user interface, a method comprising:
(A) receiving a sequence of video data packets representing a 360 degree image;
(B) assembling the video data packets in a video buffer to recreate the 360 degree image;
(C) receiving selection indicia through the user interface indicating one of all or a portion of the 360 degree image to be displayed; and
(D) displaying one of all or a portion of the 360 degree image through the user interface in accordance with the selection indicia.

10. In a computer system capable of executing a video conferencing application with a user interface, a method comprising:
(A) receiving a video data packet sequence representing a corresponding video image from one of a plurality of sources, selected of the a plurality of sources generating video images of different sizes;
(B) determining from the received video data packet sequence the size of the corresponding video image from the source;
(C) presenting the video image through a window on the user interface, the size of the window corresponding with the size of the video image from the source.

11. The method of claim 10 wherein the video data packet sequence corresponds to a 360 degree video image from the source and wherein (C) further comprises:
(C1) displaying one of all or a portion of the 360 degree image video through a window on the user interface.

12. The method of claim 11 wherein (C) further comprises:
(C2) receiving directional indicia through the user interface indicating a different portion of the 360 degree image to be viewed; and
(C3) displaying substantially continuous portions of the 360 degree image through the window on the user interface in a scrolling manner.

13. A computer program product for use with a computer system capable of executing a video conferencing application with a user interface, the computer program product comprising a computer useable medium having embodied therein program code comprising:
A) program code for receiving a video data packet sequence representing a corresponding video image from one of a plurality of sources, selected of the a plurality of sources generating video images of different sizes;
B) program code for determining from the received video data packet sequence the size of the corresponding video image from the source; and
C) program code for presenting the video image through a window on the user interface, the size of the window corresponding with the size of the video image from the source.

14. The computer program product of claim 13 wherein the video data packet sequence corresponds to a 360 degree video image from the source and wherein (C) further comprises:
(C1) program code for displaying one of all or a portion of the 360 degree image video through a window on the user interface.

15. The computer program product of claim 14 wherein (C) further comprises:
(C2) program code for receiving directional indicia through the user interface indicating a different portion of the 360 degree image to be viewed; and
(C3) program code for displaying substantially continuous portions of the 360 degree image through the window on the user interface in a scrolling manner.

16. An apparatus for use with a computer system having a processor, a device for generating a stream of video data and a mechanism for compression of captured video data, the apparatus for controlling processor utilization during video conferencing comprising:
(A) program logic for receiving a video data packet sequence representing a corresponding video image from one of a plurality of sources, selected of the a plurality of sources generating video images of different sizes;
(B) program logic for determining from the received video data packet sequence the size of the corresponding video image from the source; and
(C) program logic for presenting the video image through a window on the user interface, the size of the window corresponding with the size of the video image from the source.

17. In a computer system capable of executing a video conferencing application with a user interface, a method comprising:
(A) receiving a sequence of video data packets representing a 360 degree image;
(B) assembling the video data packets in a video buffer to recreate the 360 degree image;
(C) displaying one of all or a portion of the 360 degree image video through the user interface; and
(D) receiving a sequence of video data packets representing a non 360 degree image; and
(F) displaying the non 360 degree image video through the user interface.

18. A system for displaying 360 degree images in a video conference comprising:
(A) a source process executing on a computer system for generating sequence of video data packets representing a 360 degree image;
(B) a server process executing on a computer system for receiving the sequence of video data packets from the source process and for transmitting the sequence of video data packets to a plurality of receiving processes; and
(C) a plurality of receiving processes, each receiving process executing on a computer system, selected of the receiving processes capable of displaying one of all or a portion of the 360 degree image through a user interface.

19. The system of claim 18 wherein the source process, server process, and receiving processes are operatively coupled over a computer network.

20. The system of claim 18 wherein (C) further comprises:
(C2) program logic for receiving directional indicia through the user interface indicating a different portion of the 360 degree image to be viewed; and
(C3) program logic for displaying substantially continuous portions of the 360 degree image through the window on the user interface in a scrolling manner.
